(19) United States
(12) Patent Application Publication
(10) Pub. No.: US 2018/0215027 A1
(43) Pub. Date: Aug. 2, 2018

(54) Key Shaped Multi-Tool System for Skateboards

(71) Applicant: Donald Clayton Holm, Jr., Salt Lake City, UT (US)

(72) Inventor: Donald Clayton Holm, Jr., Salt Lake City, UT (US)

(21) Appl. No.: 15/897,103

(22) Filed: Feb. 14, 2018

(51) Int. Cl. B25F 1/00

(52) U.S. Cl. CPC B25F 1/00; B25B 13/481

(57) ABSTRACT

A multi-tool system for a skateboard, said tool system being comprised of two components that are substantially the same size as common house keys. The first key-shaped component of the tool system includes various tool elements, including a Philips head screwdriver, hexagonal key (Allen wrench) and a file surface. The second key-shaped component of the tool system includes two wrenches of different sizes. The tools elements are of sizes corresponding to common skateboard parts. The key-shaped components further include a key ring hole.

### BACKGROUND OF THE INVENTION

This disclosure relates to a tool system designed for skateboarders that provides skateboarders with the tools commonly needed to adjust or change parts when away from home or a skateboard shop. The tool system is comprised of components that are of a size and shape that may fit on a key ring. Larger tools available in the prior art inhibit the skateboarder's mobility or increase the risk of injury during a fall when carried in a skateboarder's pocket. The tool system of the present invention is designed to have components that resemble the general size and shape of common house keys and are intended to be carried on a skateboarder's key ring to satisfy the needs for safety, accessibility, portability and unobtrusiveness.

Various parts of a skateboard need adjustment from time to time. In addition, skateboarders commonly break their wooden boards and then require setup up of a new board outside of their home or a shop. There are known and commercially available various multi-tool wrenches to fit screws and bolts skateboarders need to access. These tools are often “t-shaped” or “y-shaped.” These prior art tools are relatively large, heavy and bulky, thereby making them impractical and potentially dangerous for a skateboarder to leave in his or her pocket while riding. For example, skateboarders are prone to hip injuries resulting from falling, which may be exacerbated by having a bulky metal object in their pockets. Further, the prior art tools often times lack all of the essential tools needed by a skateboarder, such as a grip tape file.

It is therefore an object of the invention to provide an improved multi-tool for skateboarders that includes all of the common essential tools needed by a skateboarder. It is further the object of the invention to provide an improved multi-tool or set of multi-tools for skateboarders that is of a size, shape and weight that allow the skateboarder to carry the tool system on in his or her key ring in his or her pocket without inconvenience or risk of injury.

### BRIEF SUMMARY OF THE INVENTION

There is therefore a need for a multi-tool that provides the commonly essential tools required by skateboarders that is of a size and shape to conveniently fit on a key ring in a pocket.

One aspect of an embodiment of the multi-tool disclosed herein is a tool or pair of tools that include the common functions needed by skateboarders, including a variety of wrenches, screwdrivers and file.

Another aspect of an embodiment of the multi-tool disclosed herein is a tool or pair of tools that are substantially the size and shape of house keys.

### BRIEF DESCRIPTION OF THE FIGURES

FIG. 1 shows the basic components of a common skateboard.

FIG. 2 shows the basic components of a common skateboard truck.

FIG. 3 shows a top view of an embodiment of a first component of the multi-tool system of the present invention.

FIG. 4 shows an perspective view of an embodiment of a first component of the multi-tool system of the present invention.

FIG. 5 shows a top view of an embodiment of a second component of a multi-tool system of the present invention.

FIG. 6 shows an embodiment of the multi-tool system of the present invention.

### DETAILED DESCRIPTION

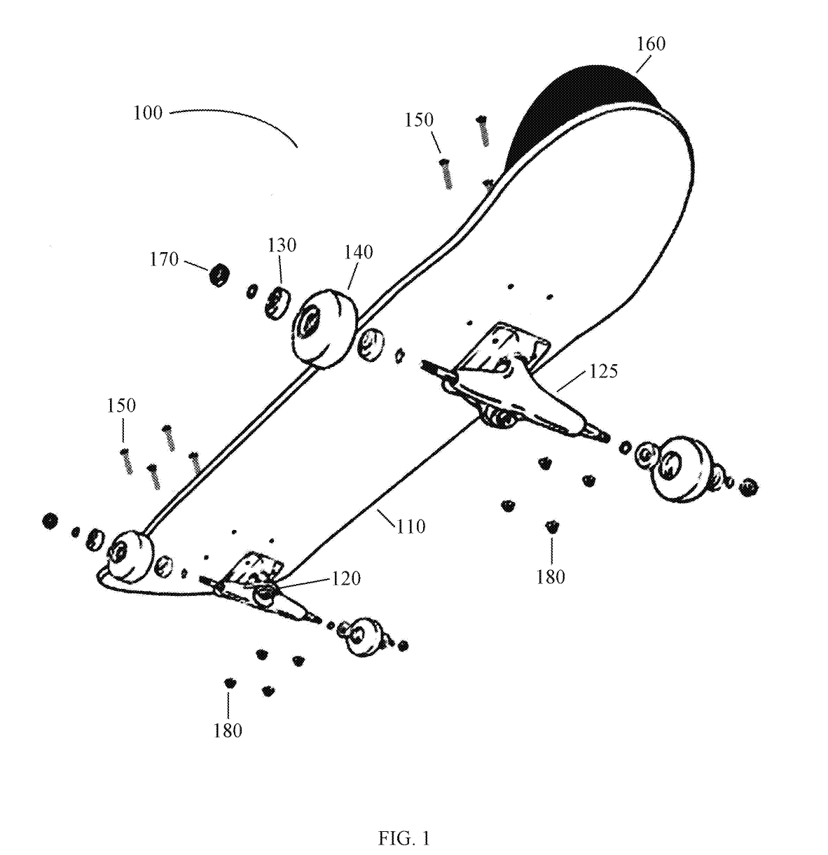

Referring to FIG. 1, the basic components of a common skateboard 100 are shown. Common skateboards include a deck 110 that typically comprises a flat wooden board that the rider stands on when skateboarding. The deck 110 may be a variety of lengths and shapes as known in the art. Attached to the deck 110 are two trucks 120, 125. Trucks 120, 125 are usually made of metal and attach to the deck 110 using bolts 150 in combination with truck nuts 180. Truck nuts 180 are commonly ⅜th inch nuts. Bearings 130 and wheels 140 are connected to the truck using axle nuts 170. On the top side of the deck 110 is grip tape 160. Grip tape 160 is typically a sheet of paper with adhesive on one side to connect the grip tape 160 to the deck 110, and a high friction surface on the other side. Grip tape 160 is applied to the deck 110 to provide the skateboard rider with better traction and control of the skateboard 100.

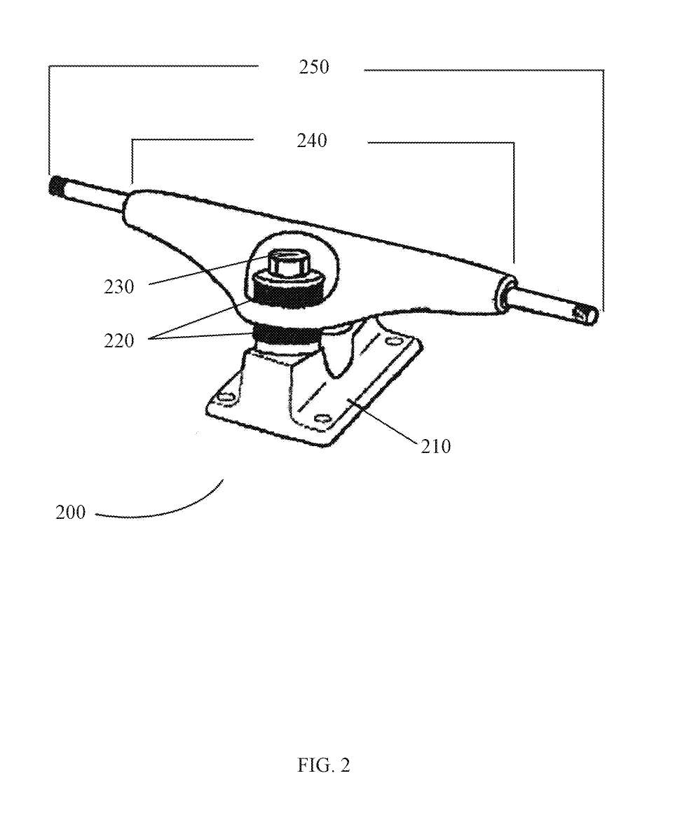

Referring to FIG. 2, the basic components of a skateboard truck 200 are shown. The baseplate 210 connects to the deck 110 through the hardware 150. Connected to the baseplate 210 is the hanger 240 through which the axle 250 runs. The wheels 140 and bearing 130 shown in FIG. 1 attach to the axle 250 and are typically held with axle nuts 170. Between the baseplate 210 and the hanger 240 are bushings 220 (also called rubber “grommets”) that provides cushioning functionality for turning the skateboard. The bushings 220 cushion the truck 200 when the rider seeks to turn the skateboard. The kingpin 230 holds the truck parts described, including the baseplate, bushings and hangar, together. The kingpin 230 is typically a bolt that fits inside the bushings 220. Tightening or loosening the kingpin 230 can therefore adjust the truck 200 for different performance desires.

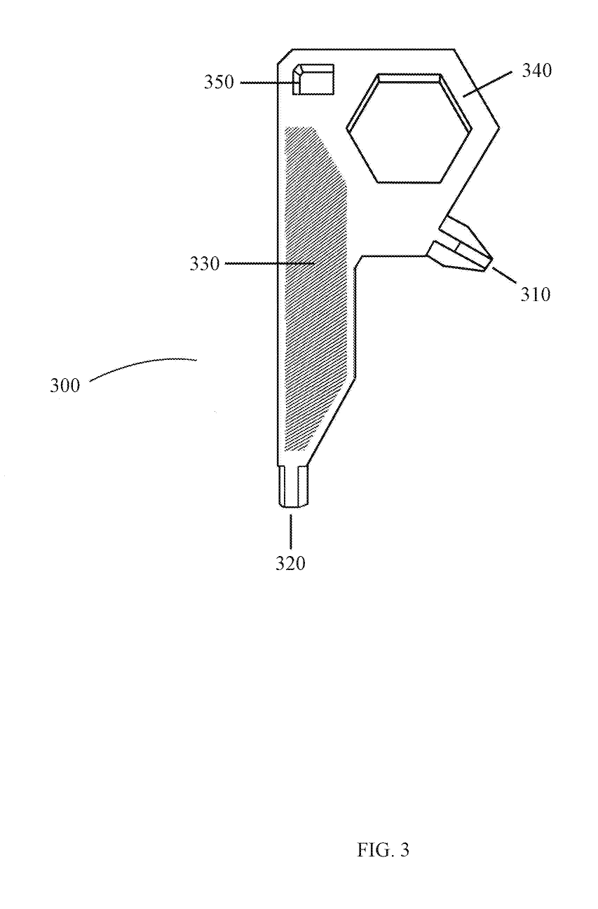

A skateboarder may have a need to fix his or her skateboard 100 or make modifications to the skateboard 100 when outside and away from standard tools. It is therefore an objective of the present invention to provide a portable multi-tool system for use with the various parts of the skateboard 100. The multi-tool system as disclosed is comprised of two key components as shown in FIGS. 3, 4 and 5.

Referring to FIG. 3, the invention is directed to a system comprised of two key-shaped multi-tool components. An embodiment of the first key-shaped component 300 of the multi-tool system includes various tool elements. As shown in FIG. 3, one tool element included in the embodiment depicted of the first key-shaped component 300 is a Philips head screwdriver tool element 310. This Philips head screwdriver tool element 310 may be useful for tightening or loosening the truck bolts 150.

Alternatively, certain truck bolts 150 use hexagonal or “Allen” screws instead of Phillips head screws. The first key-shaped component 300 of the multi-tool system disclosed herein therefore also includes a hexagonal key or Allen wrench tool element 320.

It is understood that the invention disclosed herein is not limited to the specific placements of the specific tool components depicted in the embodiments disclosed herein. For example, in alternative embodiments, the Allen wrench (or hex key) tool element 320 and the

Philips screwdriver tool element 310 may be swapped in their positions along the first key-shaped component 300.

Skateboarders also may have a need to file the edges of the grip tape 160 so that it is flush with the edge of the deck 110. The first key-shaped component 300 of the multi-tool system disclosed herein includes a file surface 330 for that purpose. In alternative embodiments, the file surface 330 may be placed on either side of the first key component 300, or on both sides of the first key component 300.

In order to adjust the trucks' kingpin bolt 230, typically a 9/16 inch wrench tool is needed. The first key-shaped component 300 of the multi-tool system disclosed herein includes a 9/16 inch wrench tool element 340 for that purpose. In the embodiment depicted in FIG. 3, the 9/16 inch wrench tool element 340 is implemented through a tool head defined by an enclosed opening within the surface of the first key-shaped component 300. In other embodiments, the 9/16 inch wrench tool may be implemented through an open head in the circumference of the first key-shaped component 300.

The first key-shaped component 300 of the multi-tool system disclosed herein is preferably of a size and shape similar to standard house keys. A key ring hole 350 is included to allow the first component 300 of the multi-tool disclosed herein to be placed a keychain.

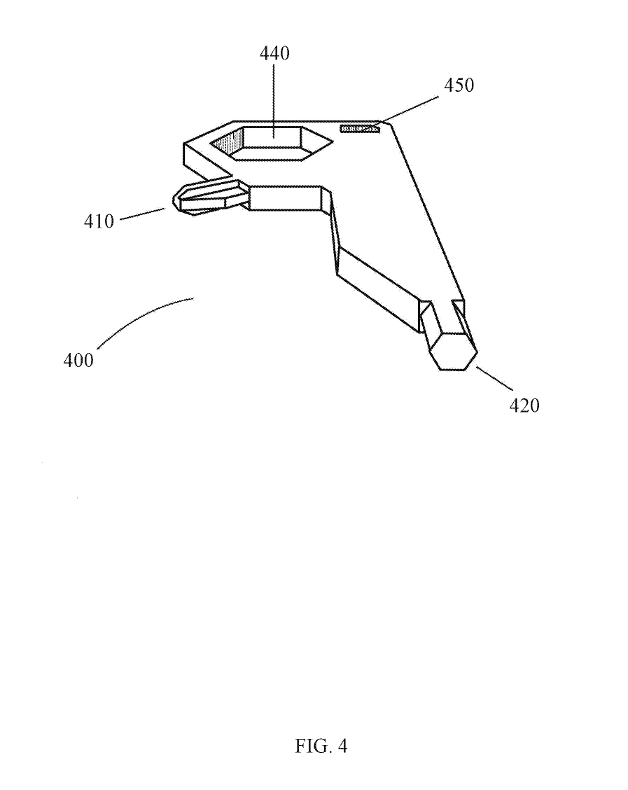

FIG. 4 shows another view of an embodiment of the first key-shaped component 400 of the multi-tool system disclosed herein as the one shown in FIG. 3. The tools included in the first key-shaped component 400 are a screwdriver 410, an Allen wrench (or hex key) 420, and a wrench 440 and a key ring hole 450.

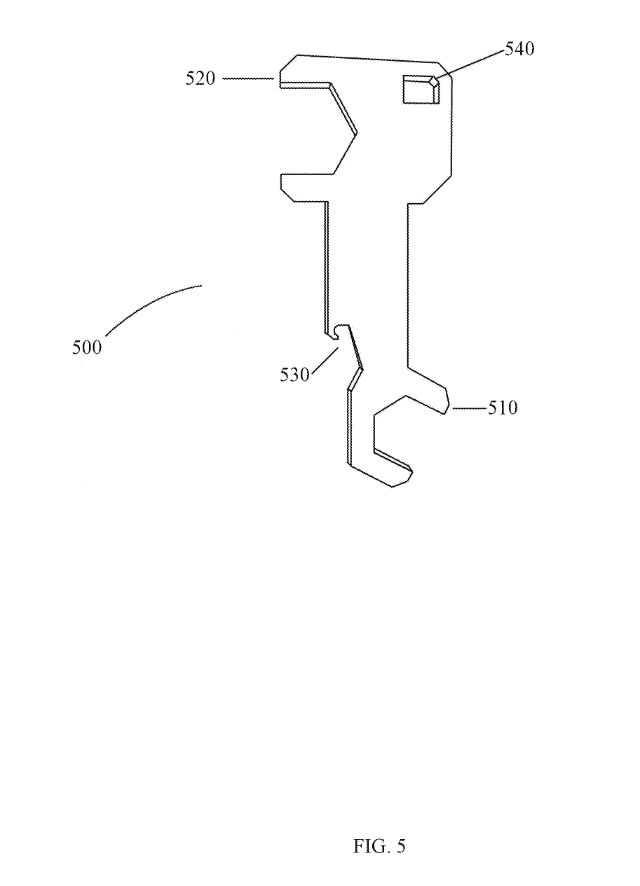

FIG. 5 shows an embodiment second key-shaped component 500 of a multi-tool system that is decoupled physically from the first key-shaped component 300. The second key-shaped component 500 includes a ⅜ inch wrench tool element 510 for use with the truck nuts 180. In the embodiment shown in FIG. 5, the ⅜th inch wrench tool is implemented with an open wrench head 510 defined by the circumference of the second key-shaped component 500. In alternative embodiments, the wrench head 510 may be implemented with a wrench head that is enclosed and defined as a hole within the surface of the second key-shaped component 500.

The second key-shaped component 500 also includes a ½ inch wrench tool element 520 for use with the axle nuts 150. In the embodiment shown in FIG. 5, the ½ inch wrench tool 520 is implemented with an open wrench head 510 defined by the circumference of the second key-shaped component 500. In alternative embodiments, the wrench head 520 may be implemented with a wrench head that is enclosed and is defined as a hole within the surface of the second key-shaped component 500.

The second key-shaped component 500 also optionally includes a bottle opener 530.

While FIG. 5 depicts the bottle opener 530 positioned such that the bottle opener 530 opening is oriented in the same direction as the ½ inch wrench tool, it is understood that the bottle opener 530 in other embodiments may not be included at all or may be positioned elsewhere along the circumference of the second key component 500. The second key component 500 is also preferably of a size and shape similar to that of common house keys and also include a key ring hole 540 so that the second component 500 can be placed on a keychain. In other embodiments, the second key component 500 may also include a file surface on either or both sides, such as show in 330 of FIG. 3.

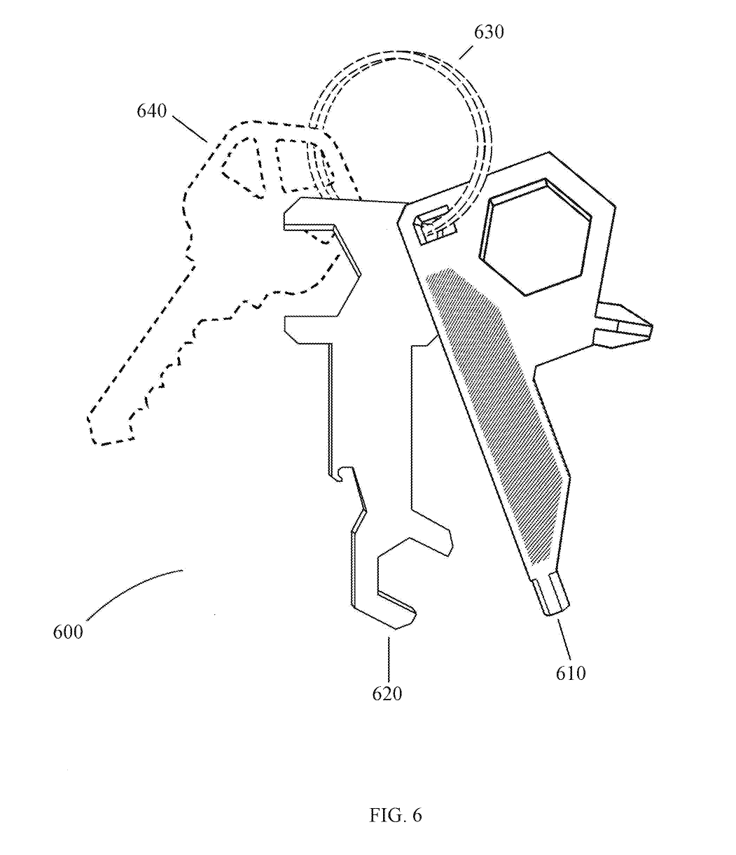

FIG. 6 depicts the multi-tool system 600 disclosed herein as the combination of the two key-shaped components 610 and 620 as they would appear placed on a key ring 630 together with a common key 640. As shown in FIG. 6, the key-shaped component 610 corresponds to the key-shaped component 300, 400 described above in connection with FIGS. 3 and 4. The key-shaped component 620 corresponds to the key-shaped component 500 described above in connection with FIG. 5.

The combination of these tool elements provides unique advantages over the prior art.

For example, the Philips head screwdriver element 310, together with the hexagonal or Allen wrench element 320 as shown in FIG. 3 in combination with the ⅜th inch wrench element 510 shown in FIG. 5 allows a skateboarder the minimum essential functionality needed to adjust or remove the truck bolts 150 and nuts 180. Because a skateboard's truck nuts 180 are commonly lined with nylon or a similar material to prevent loosening form road vibrations, the truck nuts 180 are difficult, if not impossible, to turn without a system of tools able to simultaneous access both the top and underside of the skateboard to secure and turn both the truck bolts 150 and truck nuts 180 at the same time. To achieve this functionality, certain tool elements need to be placed on separate key-shaped components 300 and 500. For example, the screwdriver tools 310, 320, must be placed on a key-shaped component separate from the ⅜ the inch wrench tool 510, so that the truck bolts 150 and nuts 180 may be torqued simultaneously with the tool components.

Other tool components, however, may be placed on either key-shaped component 300 or 400. For example, the bottle opener 530 may be placed on either the first key-shaped component 300 or second key-shaped component 500. Additionally, in alternative embodiments, the ½ inch wrench tool 520 for use with the axle nuts 150 may be placed on the first key-shaped component and the 9/16 inch wrench tool 340 for use with the kingpin 230 may be placed on the second key-shaped component.

It is understood that other embodiments of a skateboard multi-tool having the size similar to that of common keys may be utilized and remain consistent with the disclosure of the present invention. It is further understood that the particular tool elements may be provided in different combinations and locations and remain consistent with the disclosure of the present invention.

What is claimed is:

1. A multi-tool system comprising a first key-shaped device and a second key-shaped device,
wherein said first key-shaped device comprises:
a first opening in the surface of said first key-shaped device defining a key ring hole near the top end of first said key-shaped device;
a second opening in the surface of said first key-shaped device defining a nine-sixteenth inch wrench head;
a first outer edge shaped to form a Philips screwdriver head;
a second outer edge shaped to form a one-eight inch hexagonal screwdriver head;
and wherein said surface of said first key-shaped device comprises a roughened portion providing a file; and
wherein said second key-shaped device comprises:
a first opening in the surface of said second key-shaped device defining a key ring hole near the top end of first said key-shaped device;
a first outer edge shaped to form a three-eight inch wrench head;
a second outer edge shaped to form a one-half inch wrench head.

2. The multi-tool system of claim 1 wherein said second key-shaped device further comprises a third outer edge shaped to form a bottle opener.

3. A multi-tool system for a skateboard comprising a first multi-tool device and a second multi-tool device, both first multi-tool device and second mutli-tool device each being less than a quarter of an inch in thickness, less than half an inch in width and less than three inches in length, wherein:
said first multi-tool device comprises a screwdriver, a hexagonal key, a filing surface, and a wrench;
said second muti-tool device comprises two wrenches of different size; and
wherein both said first multi-tool device and said second multi-tool device each comprise a key ring hole.

4. The multi-tool system of claim 3 wherein said second multi-tool device further comprises a bottle opener.

5. A multi-tool system for use with the components of a skateboard comprising a first tool device and a second tool device, wherein:
said first tool device and said second tool device are physically decoupled from each other;
said first tool device and said second tool device are less than a quarter of an inch in thickness;
said first tool device and said second tool device are less than half an inch in width;
said first tool device and said second tool device are less than less than three inches in length;
said first tool device and said second tool device are each comprised of a hole in their respective surfaces of less than an eighth of an inch in diameter;
wherein said first tool device comprises: a means for screwing a screw having a Philips head; a means for screwing a screw having a hexagonal socket in its head; a means for filing; and a means for torqueing a nut having a first diameter; and
wherein said second tool device comprises: a means for torqueing a nut having a second diameter and a means for torqueing a nut having a third diameter.

6. The multi-tool system of claim 5 wherein said second tool device further comprises a means for opening a bottle.
